(19) United States
(12) Patent Application Publication
(10) Pub. No.: US 2007/0229486 A1
(43) Pub. Date: Oct. 4, 2007

(54) APPARATUS AND METHOD FOR DETECTING SYNC SIGNAL

(76) Inventors: Ming-Chang Liu, Changhua County (TW); Chien-Cheng Tu, Hsinchu City (TW); Kuo-Chi Chen, Changhua County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(21) Appl. No.: 11/308,971

(22) Filed: Jun. 1, 2006

(30) Foreign Application Priority Data
Apr. 4, 2006 (TW) 95111896

(51) Int. Cl. G09G 5/00

(52) U.S. Cl. 345/213

(57) ABSTRACT

An apparatus and a method for detecting the sync signal of a data signal are disclosed. The apparatus includes a clamping unit, a subtraction unit and a detection unit. The clamping unit receives the data signal and varies the level of the data signal. The subtraction unit coupled to the clamping unit subtracts the level of the data signal from that of the output of the clamping unit and then outputs the subtracting result. The detection unit coupled to the subtraction unit detects the subtracting result from the subtraction unit and judges the sync signal in the data signal accordingly.

### CROSS-REFERENCE TO RELATED APPLICATION

This application claims the priority benefit of Taiwan application serial no. 95111896, filed on Apr. 4, 2006. All disclosure of the Taiwan application is incorporated herein by reference.

### BACKGROUND OF THE INVENTION

1. Field of the Invention

The present invention relates to a display apparatus, more particularly, to an apparatus and a method for detecting whether a sync signal exists in the data signals.

2. Description of Related Art

In the horizontal synchronous control technique for a display, sync-on-green (SOG) and non-SOG are commonly deployed. In general, the display must choose a set of preset values according to the type of horizontal synchronous control technique deployed. When the display makes an erroneous judgment, for example, treating a non-SOG signal as an SOG signal, then the wrong set of preset values will be loaded leading to the generation of incorrect colors on a screen.

The circuit or apparatus for detecting conventional sync signal normally uses a micro controller unit (MCU) to determine the difference in the high/low (H/L) ratio between the decoded composite sync signal and the normal horizontal sync signal so that the presence of any sync signal in the green signal can be determined. Hence, whether the SOG technique has been used in the data signal to the display can be easily judged. FIG. 1 is a block diagram showing part of a conventional circuit for detecting a sync signal. Assume that a data signal representing a white pattern is input to this conventional display apparatus. If the data signal of this white pattern is a non-SOG signal, the timing diagram of the green signal S_{G} input to the sync separator 100 of FIG. 1 is shown in FIG. 2. On the other hand, if the data signal of this white pattern is an SOG signal, the timing diagram of the green signal S_{G} input to the sync separator 100 of FIG. 1 is shown in FIG. 4.

As shown in FIGS. 1 and 2, if the data signal is a non-SOG signal, the decoded composite sync signal H_{SG} after passing the non-SOG signal S_{G} through the sync separator 100 will have an H1/L1 ratio (as shown in FIG. 3). As shown in FIGS. 1 and 4, if the data signal is an SOG signal, the decoded composite sync signal H_{SG} after passing the SOG signal S_{G} through the sync separator 100 will have an H2/L2 ratio (as shown in FIG. 5). Therefore, the micro control unit 110 in FIG. 1 is able to use the high/low (H/L) ratio of the decoded composite sync signal H_{SG} as well as the normal horizontal sync signal H_{S} to judge whether the green signal contains a sync signal. Accordingly, whether the data signal to the display is an SOG signal can be determined.

However, the back porch of some of the input signal is rather small. As a result, the difference between the H/L ratio of the composite sync signal H_{SG} from the sync separator 100 and the H/L ratio of the normal horizontal sync signal H_{S} is exceedingly small. The similarity of the H_{SG} signal and the H_{S} signal often leads the micro controller unit 110 to judge erroneously. When the display makes an error in judging the type of signal, the wrong set of preset values will be loaded leading to the generation of incorrect colors on a screen.

### SUMMARY OF THE INVENTION

Accordingly, at least one objective of the present invention is to provide a detection apparatus capable of detecting the sync signal of a data signal and correctly identifying the type of input signal. Hence, the problem of generating incorrect colors on a screen due to filling in a wrong set of preset values after making an erroneous judgment of the sync signal can be prevented.

At least another objective of the present invention is to provide a method of detecting a sync signal capable of correctly identifying a sync or a non-sync input signal so that programming decisions can be quickly made and the correct set of preset values can be filled for normal actions.

To achieve these and other advantages and in accordance with the purpose of the invention, as embodied and broadly described herein, the invention provides a detecting apparatus for detecting the sync signal of a data signal. The detecting apparatus includes a clamping unit, a subtraction unit and a detection unit. The clamping unit receives the data signal and varies the level of the data signal. The subtraction unit subtracts the level of the data signal from that of the output of the clamping unit and then outputs the subtracting result. The detection unit is coupled to the subtraction unit for detecting the subtracting result from the subtraction unit and detecting the sync signal accordingly.

According to the foregoing detecting apparatus in one preferred embodiment of the present invention, the subtraction unit includes a first resistor, a second resistor, a third resistor, a fourth resistor and an operational amplifier. A first terminal of the first resistor receives the data signal, and a second terminal of the first resistor is coupled to a first input terminal of the operational amplifier. A first terminal of the second resistor is coupled to the clamping unit, and a second terminal of the second resistor is coupled to a second input terminal of the operational amplifier. A first terminal of the third resistor is coupled to the second terminal of the second resistor, and a second terminal of the third resistor is coupled to a ground. A first terminal of the fourth resistor is coupled to the second terminal of the first resistor, and a second terminal of the fourth resistor is coupled to an output terminal of the operational amplifier. The output terminal of the operational amplifier outputs the subtracting result.

The present invention also provides a method for detecting sync signal. The method includes varying the level of the data signal, subtracting the original data signal from the varied data signal and using the subtracting result to determine the type of sync signal.

According to the method for detecting sync signal in one preferred embodiment of the present invention, the step of varying the level of the data signal includes shifting the level of the data signal to a higher level using a clamping voltage. The step of using the subtracting result to determine the type of sync signal includes providing a reference voltage, comparing the level of the reference voltage with the subtraction result and determining the type of sync signal according to the result of the foregoing comparison. The level of the reference voltage is greater than the clamping voltage.

In the present invention, the level of the data signal is varied and then the original data signal is subtracted from the varied data signal. Hence, the judgment can be obtained quickly and the correctness of judgment is increased significantly to prevent setting the wrong set of preset values and generating incorrect colors on a screen. Moreover, unlike the conventional technique, the present invention does not need a micro control unit (MCU) so that the production cost can be reduced.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram showing part of a conventional circuit for detecting sync signal.

FIG. 2 is a graph showing a non sync-on-green (SOG) signal waveform after inputting a white pattern into the conventional sync signal detection circuit in FIG. 1.

FIG. 3 is a graph showing the composite sync signal waveform generated after inputting a non SOG signal into the conventional sync separator in FIG. 1.

FIG. 4 is a graph showing a sync-on-green (SOG) signal waveform after inputting a white pattern into the conventional sync signal detection circuit in FIG. 1.

FIG. 5 is a graph showing the composite sync signal waveform generated after inputting an SOG signal into the conventional sync separator in FIG. 1.

FIG. 6 is a block diagram of an apparatus for detecting sync signal according to the embodiment of the present invention.

FIG. 7 is a graph showing the signal waveform after shifting up the level according to the embodiment of the present invention.

FIG. 8 is a graph showing the output waveform of the subtraction unit in FIG. 6 according to the embodiment of the present invention.

FIG. 9 is a graph showing the signal waveform after the non SOG signal is shifted to a higher level by the clamping unit in FIG. 6 according to the embodiment of the present invention.

FIG. 10 is a graph showing the output waveform of the subtraction unit in FIG. 6 according to the embodiment of the present invention.

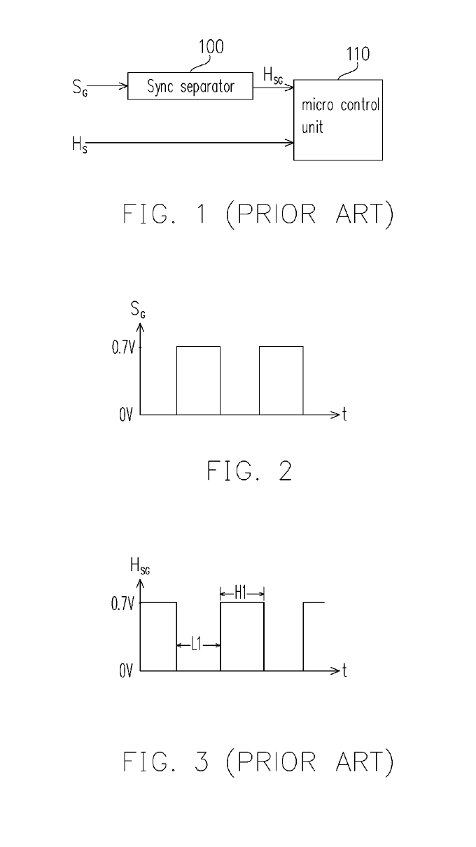

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In general, a display needs to set up corresponding preset values according to the horizontal synchronous control technique used in the data signal to be displayed. Therefore, a fast and correct judgment to identify the type of data signal is essential. More specifically, the embodiment of the present invention uses two commonly used horizontal synchronous control techniques, namely, the so-called sync-on-green (SOG) and the non sync-on-green (non-SOG), to illustrate the effects of implementation in the present invention. In other words, the following embodiments use the green data signal of the display signal as illustrative examples. However, anyone familiar with data transmission may, according to the scope and the following embodiments of the present invention, apply the claimed invention to other types of horizontal synchronous control techniques. Furthermore, to facilitate the explanation, the following embodiments use examples of inputting SOG signal and non-SOG signal with a white pattern.

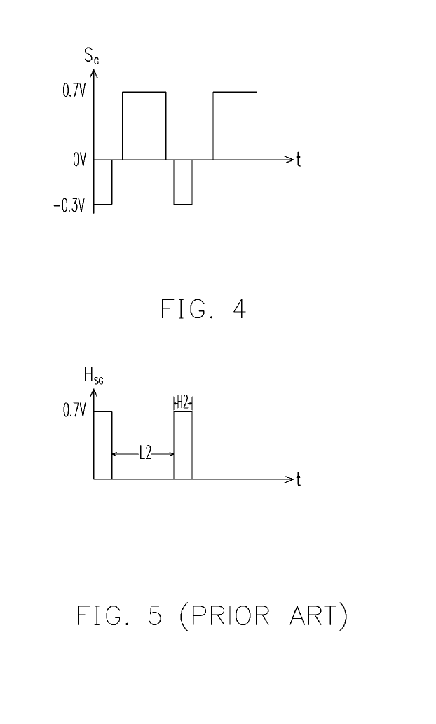

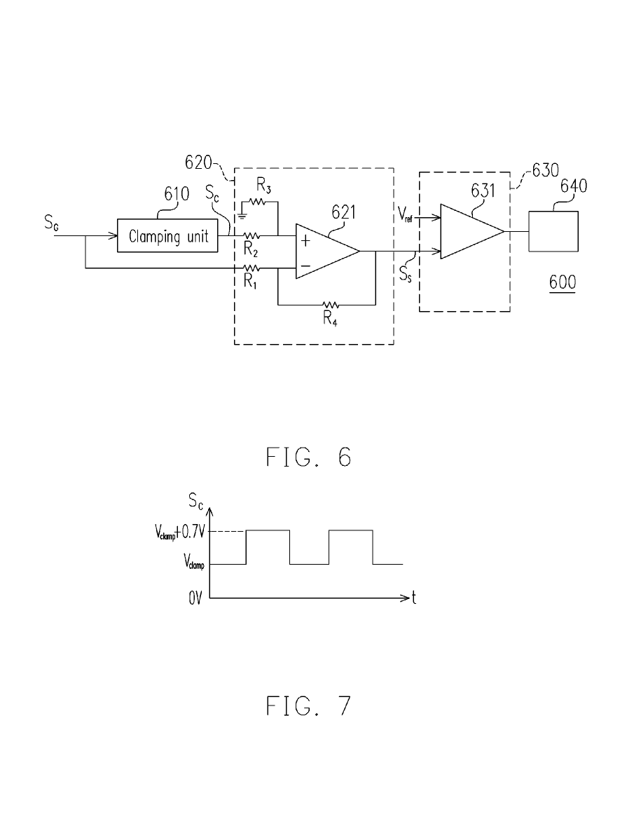

FIG. 6 is a block diagram of an apparatus for detecting sync signal according to the embodiment of the present invention. As shown in FIG. 6, the sync signal detecting apparatus 600 includes a clamping unit 610, a subtraction unit 620 and a detection unit 630. The clamping unit 610 receives and varies the level of a data signal S_{G}. In the embodiment, the clamping unit 610 shifts the level of the signal S_{G} to a higher level. In other words, a clamping voltage V_{clamp} is added to the level of the signal S_{G}. In the present embodiment, the clamping unit 610 can be implemented using a level shifter and the clamping voltage V_{clamp} is greater than the voltage swing of the sync signal in the SOG horizontal synchronous control technique. If the data signal S_{G} is a non-SOG signal (for example, as shown in FIG. 2), then the clamping unit 610 will add the clamping voltage V_{clamp} to the level of the signal S_{G} and output a shifted data signal S_{C} as shown in FIG. 7. If the data signal S_{G} is an SOG signal (for example, as shown in FIG. 4), then the clamping unit 610 will add the clamping voltage V_{clamp} to the level of the signal S_{G} and output the data signal S_{C} as shown in FIG. 9.

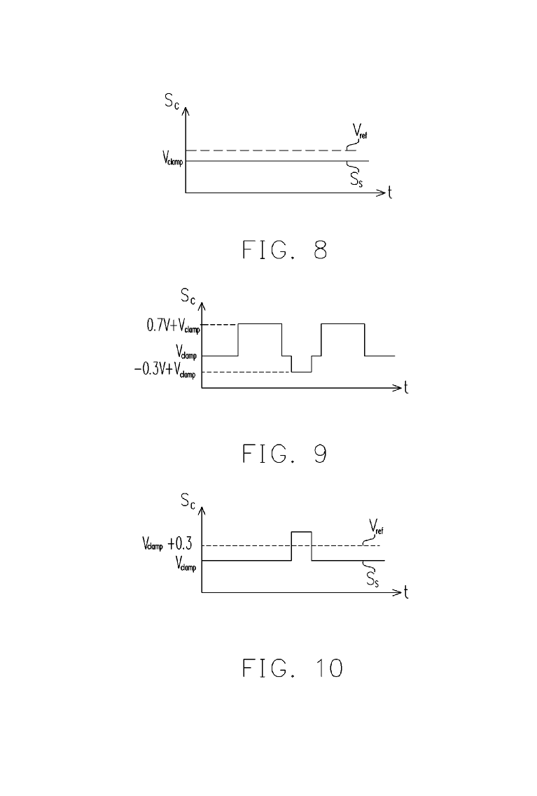

The subtraction unit 620 is coupled to the clamping unit 610. The subtraction unit 620 subtracts the original data signal (the data signal S_{G}) from the level-shifted data signal (the signal S_{C} output from the clamping unit 610) and then outputs the subtracting result S_{S}. In the present embodiment, the subtraction unit 620 includes a first resistor R₁, a second resistor R₂, a third resistor R₃, a fourth resistor R₄ and an operational amplifier 621, for example. A first input terminal (a negative input terminal in this embodiment) of the operational amplifier 621 receives the data signal S_{G} through the resistor R₁ and a second input terminal (a positive input terminal in this embodiment) is coupled to the output terminal of the clamping unit 610 through the resistor R₂. A first terminal of the third resistor R₃ is coupled to the positive input terminal of the operational amplifier 621 and a second terminal of the third resistor R₃ is connected to a ground. A first terminal of the fourth resistor R₄ is coupled to the negative input terminal of the operational amplifier 621 and a second terminal of the fourth resistor R₄ is coupled to the output terminal of the operational amplifier 621. The output terminal of the operational amplifier 621 outputs the subtracting result S_{S}. If the data signal S_{G} is a non-SOG signal, then the subtraction unit 620 will subtract the level of the data signal S_{G} shown in FIG. 2 from the level of the data signal S_{C} shown in FIG. 7 and output the subtracting result S_{S} (for example, as shown in FIG. 8). If the data signal S_{G} is an SOG signal, then the subtraction unit 620 will subtract the level of the data signal S_{G} shown in FIG. 4 from the level of the data signal S_{C} shown in FIG. 9 and output the subtracting result S_{S} (for example, as shown in FIG. 10). The detection unit 630 is coupled to subtraction unit 620 for detecting the subtracting result S_{S} from the subtraction unit 620 and determining if there is any sync signal in the data signal S_{G} accordingly. In the present embodiment, the detection unit 630 is implemented using a comparator 631. The comparator 631 compares the level between a reference voltage V_{ref} and the subtracting result S_{S} from the subtraction unit 620. Here, the level of the reference voltage V_{ref} is set to be greater than the clamping voltage V_{clamp}. If the data signal S_{G} is a non-SOG signal, refering to FIGS. 6 and 8, the comparator 631 compares the level of the reference voltage V_{ref} with the level of the subtracting result S_{S}. Since the level of the reference voltage V_{ref} is higher than the level of the subtracting result S_{S}, the output from the comparator 631 indicates that no sync signal is in the data signal S_{G} (that is, the data signal S_{G} is not an SOG signal). If the data input signal is an SOG signal, referring to FIGS. 6 and 10, the level of the subtracting result S_{S} during the sync signaling period is higher than the level of the reference voltage V_{ref}. Therefore, the comparator 631 can detect the sync signal by comparing the level between the reference voltage V_{ref} and the subtracting result S_{S}.

In summary, the level of the data signal S_{G} is shifted to a higher level to produce the signal S_{C} (that is, increasing the level by the clamping voltage V_{clamp}) after passing through the clamping unit 610. The subtraction unit 620 subtracts the data signal S_{G} from the output signal S_{C} of the clamping unit 610 and outputs the subtracting result Ss. It should be noted that there is clear difference between the non-SOG signal (refer to FIG. 8) and the SOG signal (refer to FIG. 10) after passing through the subtraction unit. Anyone familiar with the technique may set the level of the reference voltage V_{ref} and then input the subtracting result S_{S} from the subtraction unit 620 to the comparator 631. As shown in FIGS. 6, 8 and 10, the data signal S_{G} can be correctly identified as an SOG signal or not after the comparator 631 has compared the level of the subtracting result S_{S} with that of the reference voltage V_{ref}. Hence, a circuit 640 at a subsequent stage is able to determine whether the data signal S_{G} is an SOG signal or not according to the result of the detection unit 630. Consequently, the correct preset values are set to prevent the generation of incorrect colors on a screen.

Unlike the conventional technique, the level of the data signal is varied and then the original data signal is subtracted from the varied data signal in the present invention to obtain a subtracting result that determines whether the data signal contains a sync signal. Hence, the type of input data signal can be judged quickly and the correctness of judgment can be improved significantly to prevent filling in the wrong set of preset values and generating incorrect colors on a screen. In addition, the production cost is also reduced because a micro control unit (MCU) is not needed in the present invention.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An apparatus for detecting a sync signal in a data signal, comprising:
a clamping unit for receiving and varying the level of the data signal;
a subtraction unit, coupled to the clamping unit, for subtracting the level of the data signal from the output of the clamping unit and outputting a subtracting result; and
a detection unit, coupled to the subtraction unit, for detecting the subtracting result from the subtraction unit and using it to judge the sync signal.

2. The apparatus of claim 1, wherein the clamping unit comprises a level shifter.

3. The apparatus of claim 1, wherein the subtraction unit comprises:
a first resistor having a first terminal for receiving the data signal;
a second resistor having a first terminal coupled to the clamping unit;
a third resistor having a first terminal coupled to a second terminal of the second resistor and a second terminal grounded;
a fourth resistor having a first terminal coupled to a second terminal of the first resistor; and
an operational amplifier having a first input terminal coupled to the second terminal of the first resistor, a second input terminal coupled to the second terminal of the second resistor, an output terminal coupled to the second terminal of the fourth resistor, wherein the output terminal of the operational amplifier outputs the subtracting result.

4. The apparatus of claim 1, wherein the detection unit comprises:
a comparator, coupled to the subtraction unit for comparing the level of a reference voltage with the level of the subtracting result.

5. The apparatus of claim 4, wherein the clamping unit varies the level of the data signal by a clamping voltage and the level of the reference voltage is greater than the clamping voltage.

6. The apparatus of claim 1, wherein the data signal is a green data signal.

7. The apparatus of claim 1, wherein the level of the sync signal in the data signal is a negative value.

8. A method of detecting a sync signal in a data signal, comprising:
varying the level of the data signal;
subtracting the level of the original data signal from the level of the varied data signal to produce a subtracting result; and
using the subtracting result to judge the sync signal.

9. The detecting method of claim 8, wherein the step of varying the level of the data signal comprises:
shifting the level of the data signal to a higher level using a clamping voltage.

10. The detecting method of claim 8, wherein the step of using the subtracting result to judge the type of sync signal comprises:
providing a reference voltage;
comparing the level of the reference voltage with that of the subtracting result; and
judging the sync signal according to the result of the foregoing comparison.

11. The detecting method of claim 10, wherein the step of varying the level of the data signal comprises shifting the level of the data signal to a higher lever using a clamping voltage such that the level of the reference voltage is greater than the clamping voltage.

12. The detecting method of claim 8, wherein the data signal is a green data signal.

13. The detecting method of claim 8, wherein the level of the sync signal in the data signal is a negative value.
